(19) United States
(12) Patent Application Publication
(10) Pub. No.: US 2024/0208560 A1
(43) Pub. Date: Jun. 27, 2024

(54) ADAPTIVE STROLLER STORAGE SYSTEM

(71) Applicant: R. Taylor Myers, Blackstone, VA (US)

(72) Inventor: R. Taylor Myers, Blackstone, VA (US)

(21) Appl. No.: 18/088,723

(22) Filed: Dec. 26, 2022

(51) Int. Cl. B62B 9/26

(52) U.S. Cl. CPC B62B 9/26

(57) ABSTRACT

A stroller storage system which is reversibly attachable to a stroller and may be used to store items for all day outings. The stroller storage system has a flat surface, a connector system, and at least one pocket. The flat surface has an exterior side facing away from the stroller and an interior side facing towards the stroller. The at least one pocket can hold items and is connected to the exterior side of the flat surface. The connector system has at least one top connector which is reversibly attachable to the top of a stroller and at least one bottom connector which is reversibly attachable to the bottom of a stroller. The stroller storage system minimizes hazards to parents and children, preventing flopping of items, and reducing the risk of tipping. The stroller storage system adds significant usable storage space to a stroller.

### FIELD OF THE INVENTION

The invention relates to a stroller storage system which has been adapted to connect to strollers of various types for the secure storage of items, especially items related to all-day outings and theme or amusement park visits.

### BACKGROUND OF INVENTION

The prior art contains an array of stroller accessories, none of which are suitable for safely attaching to a stroller to store items for all-day outings, like theme or amusement park visits. During an all-day outing, like a visit to an amusement park, more storage space is required than is provided by a stroller. Many parents (the primary consumers of strollers) opt to carry additional bags during all-day outings, rather than purchase expensive stroller accessories which themselves only offer minimal additional unorganized storage space. Backpacks are the most common type of bag chosen by parents to accommodate the additional storage needed on these types of outings. In many cases, carrying a backpack is the only feasible option as the parents' hands are occupied with pushing a stroller. Using a backpack as additional storage comes with a downside as well; wearing a backpack for an extended period is not only uncomfortable, but it may also have negative health consequences. Chiropractors do not recommend wearing the weight of packed backpack for an extended period, because doing so can cause muscle straining, affect a person's posture, and even exacerbate pre-existing health conditions. A weeklong trip to theme park while wearing a heavy backpack could result in the development or worsening of a condition which will then require medical treatment to alleviate or correct.

While an array of stroller accessories are offered in the art, very few of them provide substantial additional storage for extended outings, like a visit to a theme park. The normal use of a stroller is to take a child (or children) along with the parent or guardian for a discreet outing, for instance a trip to the grocery store or a trip to the local park. Modern strollers are equipped with storage space which accommodates, and sometimes helps to organize, those items which a parent might need to care for a child. But storage space is often limited to only that space which would be required during normal use of the stroller. Two of the constraining factors on stroller storage space are consumer demand for strollers which are lighter-weight and strollers with increased portability. Providing more built-in storage space a stroller, with proper organizational features, would increase the weight of a stroller and complicate the folding (and reduce the portability) of the stroller. Additional storage is required when using a stroller for an all-day outing, like a visit to a theme park. When visiting a theme park, parents not only have to travel with the usual essential items for a child (or children) in a stroller, but also have to carry additional supplies which are usually kept at home, such as blankets for naps, extra snacks, extra drinks, fans, toys, batteries, and supplies/clothing for inclement/changing weather. Even more storage may be needed for any items acquired on all-day outings; a trip to a theme park often involves the purchasing of memorabilia and toys for the children (including items, like light wands). Strollers do not have enough built-in storage to accommodate these additional items, which usually results in the parents carrying a backpack (which comes with its own downsides) or opting for an accessory to the stroller to provide additional storage space.

Stroller accessories in the prior art fail to adequately address the needs of consumers; they do not provide enough storage space and their use presents hazards for parents and children. Stroller accessories in the prior art typically comprise a small bag with hooks that can be attached to the handles or handlebar of a stroller, which provides a minimal amount of extra storage space for a stroller. These accessories are minimal by design, because attaching anything to a stroller presents a hazard to parents and children. The hazard to the parent (the one operating the stroller) comes from the swinging of the attached item. Strollers are designed for movement, and their built-in components (including storage space) are design to be stable and/or level when the stroller is being pushed, but attachments to strollers are not designed in the same way and often flop around or swing when the stroller is in motion. If the items stored in the attached accessories are few and lightweight (due to the stroller accessory being designed to only provide minimal space), then the swinging/flopping of the attachment presents a minimal, but still significant, hazard. But if an accessory were designed to accommodate more storage space, providing for the storage of the many items and supplies required for all-day outings, then that accessory would present a severe hazard to the parent, and possibly to passersby as well.

Accessories and bags attached to strollers are also hazardous for children. Strollers are typically designed to prevent tipping. Tipping a stroller could cause the child within that stroller to fall out and/or be severely injured. The storage area of a stroller is designed with tipping in mind, which often results in storage areas being placed under the seat of the stroller, or somewhere close to the ground: to lower the center of gravity of the stroller and ensure safety for the child. Stroller attachments and accessories, especially those that swing and flop around, significantly increases the risk of tipping a stroller.

There exists a need for a stroller storage system which attaches to a stroller to provide additional organized storage space to accommodate all-day outings with a child, while also minimizing any hazards or dangers to the parent and child from that stroller storage system.

### BRIEF SUMMARY OF THE INVENTION

The present invention provides a stroller storage system which attaches to a stroller to provide additional organized storage space to accommodate all-day outings with a child, while also minimizing any hazards or dangers to the parent and child from that stroller storage system.

An embodiment of the stroller storage system for adding storage to a stroller comprises a pocket support panel having a top portion and a bottom portion. The pocket support panel having an exterior side and an interior side, the interior side being configured to face a rear side of the stroller, the exterior side being configured to face away from the stroller. The pocket support panel may be a flexible fabric, sheet, or film.

The stroller storage system comprises at least one pocket connected to the exterior side of the pocket support panel. In some embodiments, the stroller storage system comprises multiple pockets and other storage accessories.

The stroller storage system comprises a connector system for connecting the stroller storage system to a rear side of the stroller. A stroller storage system connected to the rear of the stroller under the handle provides easy access to item stored in the pockets or other features of the stroller storage system.

In one embodiment, the connector system comprises releasable connectors that connect the stroller storage system between a handle frame and a rear frame of a stroller. The connector system supports the stroller storage system in an extended state and sufficiently taut. The pocket support panel is sufficiently taut is the swing more than 5 degrees from the handle frame or as items are added to or removed from the pockets.

In a certain embodiment, the connector system comprises at least one bottom connector connected to the bottom portion of the pocket support panel and being reversibly attachable to a at least one bottom frame component of a stroller such that the pocket support panel is securely supported and tautly extended between the handle assembly and the bottom frame component.

In some embodiments, the stroller storage system comprising two top connectors comprising a right top connector and a left top connector, wherein the right top connector is connected to a right side of the handle assembly and the left top connector is connected to the left side of the handle assembly.

In such embodiments, the stroller storage system may comprise two bottom connectors comprising a right bottom connector and a left bottom connector. The right bottom connector may be connected to a right side of the at least one bottom frame component (adjacent the right rear wheel, for example) and the left bottom connector is connected to the left side of the at least one bottom frame component (adjacent the left rear wheel, for example).

In one embodiment, the reversible connectors are connected to the corners of the pocket support panel. For example, the right bottom connector is adjacent to the right bottom corner of the pocket support panel, the left bottom connector is adjacent to the left bottom corner of the pocket support panel, the right top connector is adjacent to the right top corner of the pocket support panel, and a left top connector is adjacent to the left top corner of the pocket support panel.

Since the pocket support panel is securely connected to the handle frame and the rear wheel frame the pocket support panel may angle inward towards the rear of the stroller. This keeps the stroller storage system from interfering with the users walking by swinging into or otherwise interfering with their stride.

An embodiment of the present invention comprises a pocket support panel, at least one pocket, and a connector system. The pocket support panel comprises and exterior side and an interior side. The exterior side faces away from a stroller, and the interior side faces towards a stroller. The at least one pocket is connected to the exterior side of the pocket support panel, and the at least one pocket is configured to hold items. The connector system comprises at least one top connector and at least one bottom connector. The at least one top connector and the at least one bottom connector are attached to the pocket support panel. The at least one top connector is configured to be reversibly attachable to the top of a stroller, and the at least one bottom connector is configured to be reversibly attachable to the bottom of a stroller. The connector system prevents the stroller storage system from flopping around or swinging and reduces the risk of tipping the stroller. One embodiment of the invention comprises approximately 2 cubic feet of usable storage space. The stroller storage system is able to accommodate the storage needs of parents taking their child on long trips or all-day outings, such as theme/amusement park visits.

Aspects of the stroller storage system are presented in various embodiments, however one skilled in the art will understand various variation and interchangeability of the components of the various embodiments which are intended to be included in the scope of the invention.

### BRIEF DESCRIPTION OF THE DRAWINGS

The above and other objects, features and advantages will be more clearly understood and appreciated from the following Detailed Description of the present invention when taken in conjunction with the accompanying drawings which illustrate the stroller storage system:

FIG. 1 is a front view of an embodiment of the stroller storage system, showing the exterior side of the pocket support panel of a stroller storage system broken away from a stroller for clarity of illustration.

FIG. 2 is an enlarged front view of an embodiment of the stroller storage system, showing a pocket partially broken away from a stroller storage system for clarity of illustration.

FIG. 3 is a rear view of an embodiment of the stroller storage system, showing the interior side of the pocket support panel of a stroller storage system broken away from a stroller for clarity of illustration.

FIG. 4a-4c are an enlarged rear view of an embodiment of the stroller storage system, showing a connector partially broken away from a stroller storage system for clarity of illustration.

### DETAILED DESCRIPTION

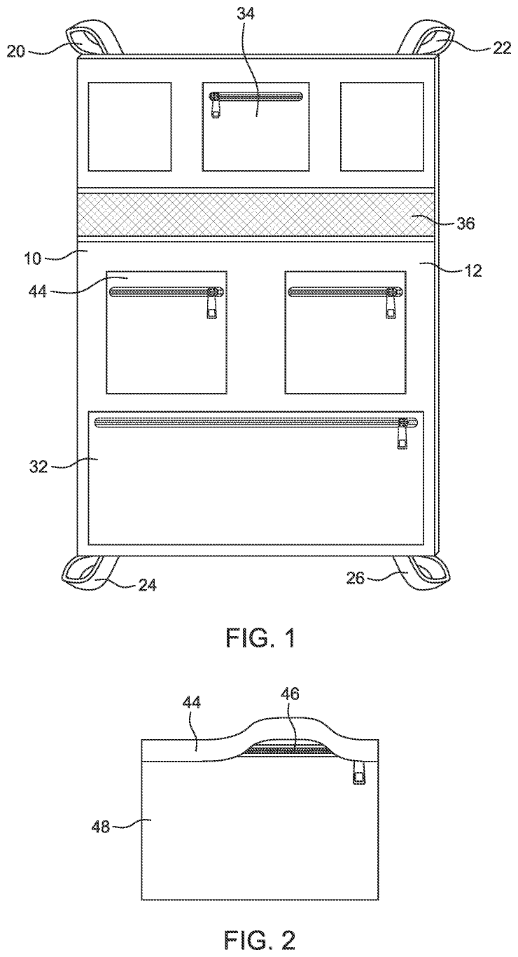

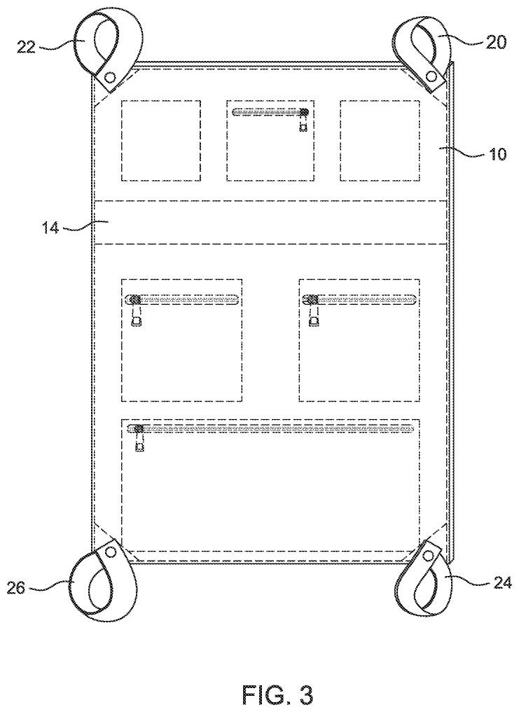

Now looking to FIG. 1 and FIG. 3, an embodiment of the stroller storage system comprises a pocket support panel 10, at least one pocket, and a connector system. The pocket support panel 10 comprises an exterior side 12 and an interior side 14. The exterior side 12 may be configured to face away from a stroller, while the interior side 14 may be configured to face towards a stroller. The pocket support panel 10 may be made of any suitable material which is able to maintain its integrity despite the forces exerted upon it by the connector system and the at least one pocket. The stroller storage system comprises at least one pocket. The at least one pocket is able to store items, and the pocket may be configured to be opened and closed. The connector system may be used to connect the stroller storage system to a stroller.

In one embodiment of the invention, the connector system comprises at least one top connector, and at least one bottom connector. The at least one bottom connector may be reversibly attachable to the top of a stroller, and the at least one bottom connector may be reversibly attachable to the bottom of a stroller. The top of a stroller does not mean, the furthest point on the stroller from the ground, but simply refers to some upper portion of the stroller, including, but not limited to the handle, the handlebar, the transverse support bar which connects the handles or handlebars, the top of the seat, or support bar near the top of the seat. Likewise, the bottom of a stroller does not refer to the closest point on the stroller to the ground, but simply refers to some lower portion of the stroller, including, but not limited to the strut, the rear strut, the side strut, the wheel, the axel, the transverse support bar which connects the struts or the wheels, the bottom of the seat, or support bar near the bottom of the seat. The at least one top connector and the at least one bottom connector are able to secure the stroller storage system to a stroller, ensuring that the stroller storage system does not flop around when the stroller is in motion and reducing the risk of tipping.

In one embodiment of the invention, the stroller storage system comprises approximately 2 cubic feet of usable storage space. In additional embodiments, the stroller storage system provides between 1 cubic foot of usable storage space and 10 cubic feet of additional storage space.

There exist various types of strollers in the art, including, but not limited to, umbrella strollers, lightweight strollers, full-size strollers, jogging strollers, travel strollers, multi-seat strollers, stroller wagons, and hybrid strollers. Some strollers don't fit neatly into the listed categories, due to their combinations of features. Even with the tremendous variation between strollers, they share a few common features, like wheels, a seat, and handles. The present invention comprises a connector system which allows for the reversible attachment of the stroller storage system to a stroller. One embodiment of the invention comprises a connector system which allows the stroller storage system to be reversibly attached to the components of a stroller which are common or substantially similar between the various types of strollers. Additional embodiments of the present invention comprise connectors which are configured to be reversibly attachable to specific types, or combinations of types, of strollers. Certain types of strollers, like umbrella strollers, are lightweight and prone to tipping if too much weight is added to certain areas of the umbrella stroller. In one embodiment of the invention, the connector system is configured to connect the stroller storage system to an umbrella stroller. In one embodiment, the connector system may be made of a lightweight or low-density material, or may include counterweights, to reduce the potential of tipping an umbrella stroller. Certain types of strollers also have different components parts. For instance, stroller wagons comprise different support bars and structures than those of full-size strollers. In one embodiment of the invention, the connector system may be configured to allow the stroller storage system to be reversibly connected to a full-size stroller. In another embodiment, the connector system comprises at least one top connector and at least one bottom connector, each of which are configured to be reversibly attachable to a stroller wagon.

In one embodiment of the invention, the at least one top connector comprises a left top connector 20 and a right top connector 22. The left top connector 20 and right top connector 22 are reversibly attachable to the top of a stroller. In another embodiment, the at least one bottom connector comprises a left bottom connector 24 and a right bottom connector 26. The left bottom connector 24 and the right bottom connector 26 are reversibly attachable to the bottom of a stroller. In yet another embodiment of the invention, the at least one top connector comprises a left top connector 20 and a right top connector 22, and the at least one bottom connector comprises a left bottom connector 24 and a right bottom connector 26. The left top connector 20 and right top connector 22 are reversibly attachable to the top of a stroller, and the left bottom connector 24 and the right bottom connector 26 are reversibly attachable to the bottom of a stroller. In one embodiment, the left top connector 20 and the right top connector 22 are coplanar. In another embodiment, the left bottom connector 24 and the right bottom connector 26 are coplanar. In another embodiment, the left top connector 20 is reversibly attachable to the left handlebar of a stroller, the right top connector 22 is reversibly attachable to the right handlebar of a stroller, the left bottom connector 24 is reversibly attachable to the left rear strut of a stroller, and the right bottom connector 26 is reversibly attachable to the right rear strut of a stroller. In another embodiment, the left top connector 20, the right top connector 22, the left bottom connector 24, and the right bottom connector 26 each comprise a snap connector.

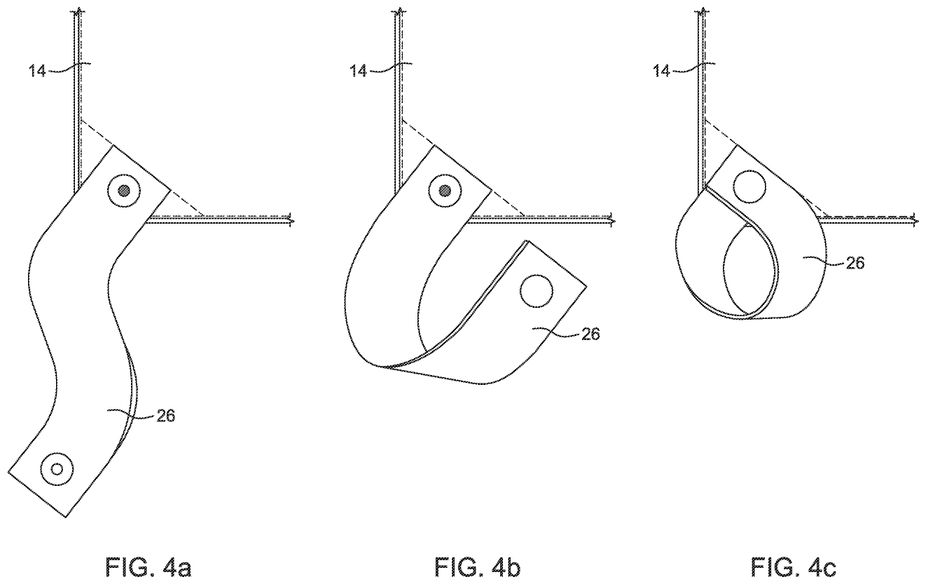

Now looking to FIG. 4c, FIG. 4b, and FIG. 4c, an embodiment of the invention comprises a right bottom connector 26 which has a snap connector. The snap connector may be opened to allow the right bottom connector 26 to wrap around the right rear strut of a stroller.

The snap connector may then be closed to attach the right bottom connector 26 to the right rear strut of a stroller. In additional embodiments, the connector system comprises different types of connectors, including, but not limited to, hook and loop connectors, locks, buckles, interference fits, magnetic connectors, snap connectors, or some combination thereof. The connector may be any type of connector including, but not limited to, velcro, hook and loop connectors, zippers, hooks and eyes, toggle fasteners, buckles, snaps, ties, buttons and buttonholes, hooks, and/or other fasteners.

Now looking to FIG. 1 and FIG. 2, in additional embodiments of the invention, the at least one pocket comprises a plurality of pockets. In one embodiment, the at least one pocket comprises two portions, a storage portion 48 and an opening portion 46. The storage portion 48 defines a cavity and is configured to store items, and the opening portion 46 defines an opening and is configured to allow items to be placed in, and removed from, the storage portion. In this embodiment, the at least one pocket comprises a cover 44. The cover 44 may be configured to conceal the opening portion 46. In another embodiment of the invention, the cover 44 may configured to inhibit the ingress and egress of materials through the opening portion 46. In some instances, the term ‘materials’ is more inclusive than the term ‘items.’ Items include those things which one may intentionally store in a stroller or stroller storage system. Materials includes items, but also includes things like water from rain, groundwater, dust, pollen, etc. In another embodiment, the cover 44 may be configured to insulate the items stored in the storage portion 48. In yet another embodiment, the cover 44 may be configured for theft protection, preventing easy access to the items in the storage portion 48. In one embodiment, the cover 44 is configured for theft protection and comprises a lock.

In one embodiment of the invention, the at least one pocket comprises an electronics pocket 34 connected to the exterior side 12 of the pocket support panel 10, the electronics pocket 34 being configured to store electronics, including, but not limited to, mobile phones, tablets, tablet computers, personal computers, laptops, electronic toys, or some combination thereof. The configuration of a pocket to safely store electronics is well known in the art. In one embodiment of the invention, the at least one pocket comprises a cooler pocket 32. The cooler pocket 32 may be connected to the exterior side of the pocket support panel and may be configured to insulate items stored in the cooler pocket. In another embodiment, the at least one pocket comprises a net pocket 36. The net pocket 36 is made of a netted material. In yet another embodiment, the at least one pocket comprises a mesh pocket. The mesh pocket is made of a mesh material. In one embodiment, the at least one pocket comprises a transparent pocket. The transparent pocket may be made of a material that is substantially transparent and may allow the user of the stroller storage system to easily view the contents of the pocket. In another embodiment, the at least one pocket comprises a translucent pocket. The translucent pocket may be made of a material that is substantially transparent and may allow the user of the stroller storage system to view the contents of the pocket. In one embodiment, the at least one pocket comprises an umbrella holder. The umbrella holder may be configured to hold an umbrella. In another embodiment, the at least one pocket comprises a light wand pocket. Light wands are common in theme parks, amusement parks, etc. The light wand pocket may be configured to hold a light wand. In additional embodiments, the at least one pocket comprises a pocket with either a zipper, Velcro, a clasp, a combination lock, a key lock, an electronic lock, or some combination thereof. One embodiment of the stroller storage system comprises at least one pocket, wherein the at least one pocket is connected to the interior side 14 of the pocket support panel 10. Additional embodiments of the invention comprise more than one pocket, wherein at least one pocket is connected to the interior side 14 of the pocket support panel 10 and at least one pocket is connected to the exterior side 12 of the pocket support panel 10.

In additional embodiments of the stroller storage system, the pocket support panel 10 comprises different types of material, or some combination thereof. In additional embodiments, the pocket support panel 10 comprises a fabric material (including, but not limited to, synthetic fabric, or fabric that is knitted, woven, embroidered, or some combination thereof), a plastic material, aluminum, copper, another metal (or metal alloy), or some combination thereof. In one embodiment, the pocket support panel 10 comprises a waterproof material, while in another embodiment, the pocket support panel 10 comprises a water-resistant material. In one embodiment the pocket support panel 10 comprises an insulating material. In one embodiment, the pocket support panel 10 comprises a heat resistant material, while in another embodiment, the pocket support panel 10 comprises a reflective material. In yet another embodiment of the invention, the pocket support panel 10 comprises a designated portion configured for customization, decoration, or some combination thereof. In one embodiment, the pocket support panel 10 comprises a flexible or bendable material. In another embodiment, the pocket support panel 10 comprises multiple flat layers of at least one material.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. A stroller storage system for adding storage to a stroller, comprising:
a pocket support panel having a top portion and a bottom portion, the pocket support panel having an exterior side and an interior side, the interior side being configured to face a rear side of the stroller, the exterior side being configured to face away from the stroller;
at least one pocket connected to the exterior side of the pocket support panel, the at least one pocket being configured to store items; and
a connector system, the connector system comprising:
at least one top connector connected to the top portion of the pocket support panel and reversibly attachable to a handle assembly of the stroller; and
at least one bottom connector connected to the bottom portion of the pocket support panel and being reversibly attachable to a at least one bottom frame component of a stroller such that the pocket support panel is securely supported and extended between the handle assembly and the bottom frame component.

2. The stroller storage system of claim 1, wherein the at least one top connector and the at least one bottom connector are configured to be reversibly attachable to an umbrella stroller.

3. The stroller storage system of claim 1, comprising two top connectors comprising a right top connector and a left top connector, wherein the right top connector is connected to a right side of the handle assembly and the left top connector is connected to the left side of the handle assembly.

4. The stroller storage system of claim 3, comprising two bottom connectors comprising a right bottom connector and a left bottom connector, wherein the right bottom connector is connected to a right side of the at least one bottom frame component and the left bottom connector is connected to the left side of the at least one bottom frame component.

5. The stroller storage system of claim 4, wherein the right bottom connector is adjacent to the right bottom corner of the pocket support panel, the left bottom connector is adjacent to the left bottom corner of the pocket support panel.

6. The stroller storage system of claim 1, wherein the pocket support panel extend inwardly toward the rear of the stroller.

7. The stroller storage system of claim 1, wherein the stroller storage system provides between 1 cubic foot of usable storage space and 10 cubic feet of usable storage space.

8. The stroller storage system of claim 1, wherein the stroller storage system provides 1.8-2.2 cubic feet of usable storage space.

9. The stroller storage system of claim 1, wherein the pocket support panel comprises a waterproof material, an insulating material, a heat resistant material, or some combination thereof.

10. The stroller storage system of claim 1, wherein the pocket support panel comprises a designated portion configured for customization, decoration, or some combination thereof.

11. The stroller storage system of claim 1, wherein the at least one pocket comprises a cooler pocket, the cooler pocket being connected to the exterior side of the pocket support panel.

12. The stroller storage system of claim 1, wherein the at least one pocket comprises at least one net pocket, at least one mesh pocket, at least one transparent pocket, the at least one transparent pocket being substantially transparent, at least one translucent pocket, the at least one translucent pocket being substantially translucent, or some combination thereof.

13. The stroller storage system of claim 1, wherein the at least one pocket comprises an electronics pocket, the electronics pocket being configured to store at least one mobile phone, tablet, tablet computer, personal computer, electronic toy, or some combination thereof.

14. A stroller storage system on a stroller, comprising:
a stroller comprising a handle frame, a rear wheel frame, and a front wheel frame;
a pocket support panel comprising a fabric panel, the pocket support panel having an exterior side and an interior side, the interior side being configured to face a rear of the stroller and the exterior side being configured to face away from the stroller;
at least one pocket connected to the exterior side of the pocket support panel, the at least one pocket being configured to opened and closed to store items; and
a connector system to connect the pocket support panel to the handle frame and to the rear wheel frame, the connector system comprising a right handle frame connector reversibly connected to the handle frame, a left handle frame connector reversibly connected to the handle frame, a right rear wheel frame connector reversibly connected to the rear wheel frame, and a left rear wheel frame connector reversibly connected to the handle frame.

15. The stroller storage system of claim 14, wherein the connector system is configured to be § reversibly attachable to an umbrella stroller.

16. The stroller storage system of claim 14, wherein the stroller storage system provides between 1 cubic foot of usable storage space and 10 cubic feet of usable storage space.

17. The stroller storage system of claim 14, wherein the stroller storage system provides 1.8-2.2 cubic feet of usable storage space.

18. The stroller storage system of claim 14, wherein the connector system is configured to be reversibly attachable to at least one of a full-size stroller, a stroller wagon, a jogging stroller, a multi-seat stroller.

19. The stroller storage system of claim 14, wherein the pocket support panel comprises a flexible fabric material.

20. The stroller storage system of claim 14, wherein the pocket support panel comprises multiple flat layers of at least one material.

21. The stroller storage system of claim 14, wherein the at least one pocket comprises a cooler pocket, the cooler pocket being connected to the exterior side of the pocket support panel.

22. The stroller storage system of claim 14, wherein the at least one pocket comprises at least one net pocket, at least one mesh pocket, at least one transparent pocket, the at least one transparent pocket being substantially transparent, at least one translucent pocket, the at least one translucent pocket being substantially translucent, or some combination thereof.

23. The stroller storage system of claim 14, wherein the at least one pocket comprises an electronics pocket, the electronics pocket being configured to store at least one mobile phone, tablet, tablet computer, personal computer, or some combination thereof.
